(19) United States
(12) Patent Application Publication
(10) Pub. No.: US 2013/0175420 A1
(43) Pub. Date: Jul. 11, 2013

(54) POSITIONING SYSTEM

(71) Applicant: Eyal Dror, Moshav Asseret (IL)

(72) Inventor: Eyal Dror, Moshav Asseret (IL)

(73) Assignee: ETERNEGY LTD., D.n. Arava (IL)

(21) Appl. No.: 13/824,408

(22) PCT Filed: Dec. 29, 2011
(86) PCT No.: PCT/IB11/56015

§ 371 Date: Mar. 27, 2013

(30) Foreign Application Priority Data
Feb. 10, 2011 (GB) 1102347.0

(51) Int. Cl. F16M 11/18

(52) U.S. Cl. CPC F16M 11/18
USPC 248/371

(57) ABSTRACT

A utility platform (110) holding solar modules (91) and supported by a ground support (90), that is reinforced by upper suspension elements (130) connected to extensions (120) of the ground support, and by lower taut cords (140) connected to a motor (150) controlling their lengths and tension. The upper suspension elements (130) are arranged to support a weight of the platform (110), and together with the taut cords (140) are arranged to maintain a form of the utility platform (110) at a range of specified orientations and under a range of wind intensities, by generating a resultant force that is opposite to a wind direction on an upwind side of the utility platform, the upwind side being either the upper side or the lower side, according to the wind direction and the specified orientation.

### BACKGROUND

1. Technical Field

The present invention relates to the field of positioning systems, and more particularly, to a utility platform for carrying solar modules.

2. Discussion of Related Art

WIPO patent document No. 2010016060 discloses a structural support and tracking system comprising a utility platform defining an X-Y plane and supported over a central support post defining a longitudinal axis Z being normal to the plane X-Y. The utility platform comprises at least three platform cord connection elements, at least three left ground cord connection elements associated with two left platform cord connection elements, and at least one right ground cord connection element associated with at least one right platform cord connection element (PCCE). A tension cord system wherein a cord extends from each platform cord connection element towards at least one corresponding ground cord connection element, and a manipulating system for tilting the utility platform by tension adjustment of the cords.

### BRIEF SUMMARY

Embodiments of the present invention provide a positioning system for holding solar modules, comprising: a utility platform arranged to hold the solar modules, the utility platform connected to at least one ground support at at least one supporting link, and defines a plane having an upper side and a lower side, at least one extension connected to utility platform and projecting above the upper side of the utility platform, a plurality of upper suspension elements connecting the at least one extension to a plurality of upper contact points on the utility platform, a plurality of taut cords connecting a plurality of lower contact points on the utility platform to at least one ground motor that is arranged to change an orientation of the utility platform by controlling lengths and tensions of the taut cords, and a controller arranged to coordinate the at least one ground motor to achieve a specified orientation of the utility platform under specified ranges of tensile forces in the taut cords; wherein the upper suspension elements are arranged to support a weight of the utility platform, and further arranged, together with the taut cords, to maintain a form of the utility platform at a range of specified orientations and under a range of wind intensities, by generating a resultant force that is opposite to a wind direction on an upwind side of the utility platform, the upwind side being either the upper side or the lower side, according to the wind direction and the specified orientation.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1-14 schematically illustrate a positioning system for solar modules, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner: The term “solar module” as used herein in this application, is defined as any element used for absorption, reflection, or concentration of solar irradiance, such as flat or concave solar panels, flat or concave mirrors or reflectors, lens, or other optical elements. The term “ground element” as used herein in this application, is defined as any element that couples cords to the ground, such as a fixed connection, a pulley, a sheave, a ratchet, or a motor of any kind.

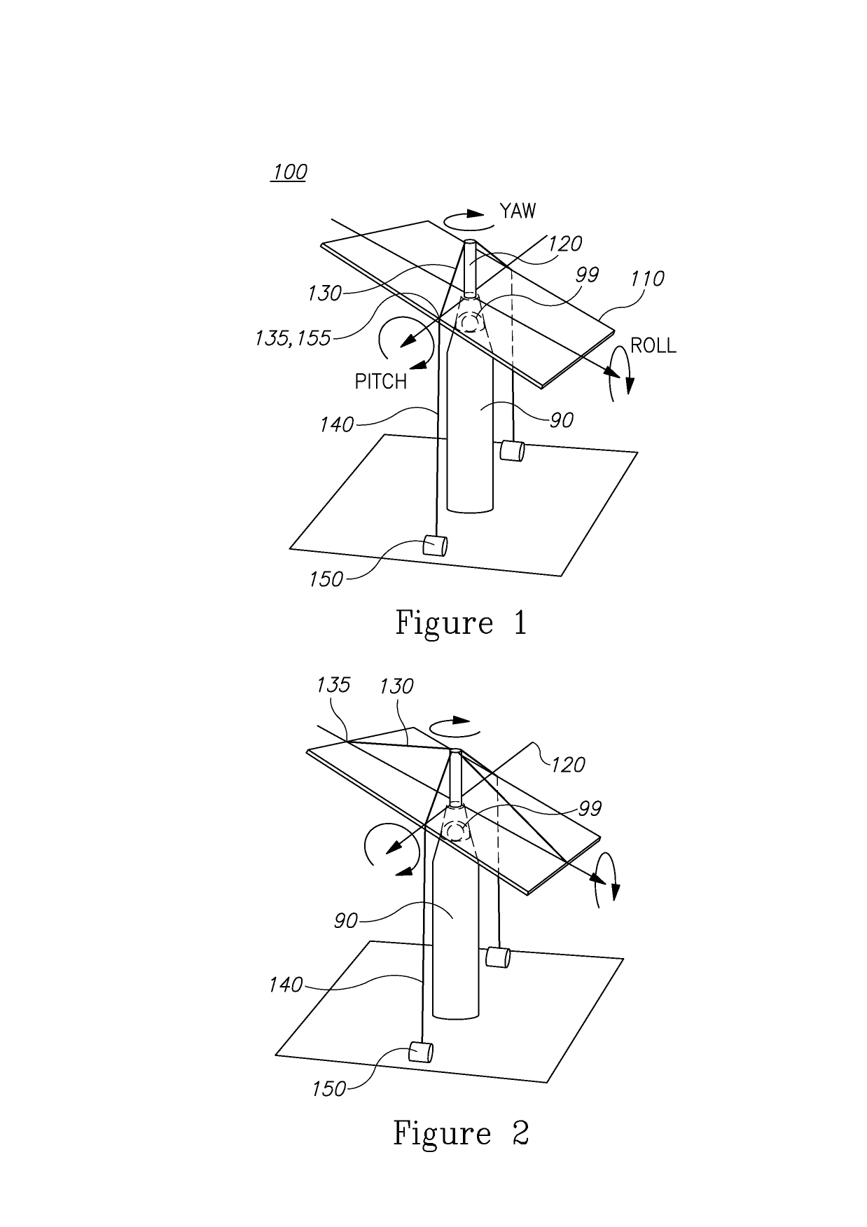

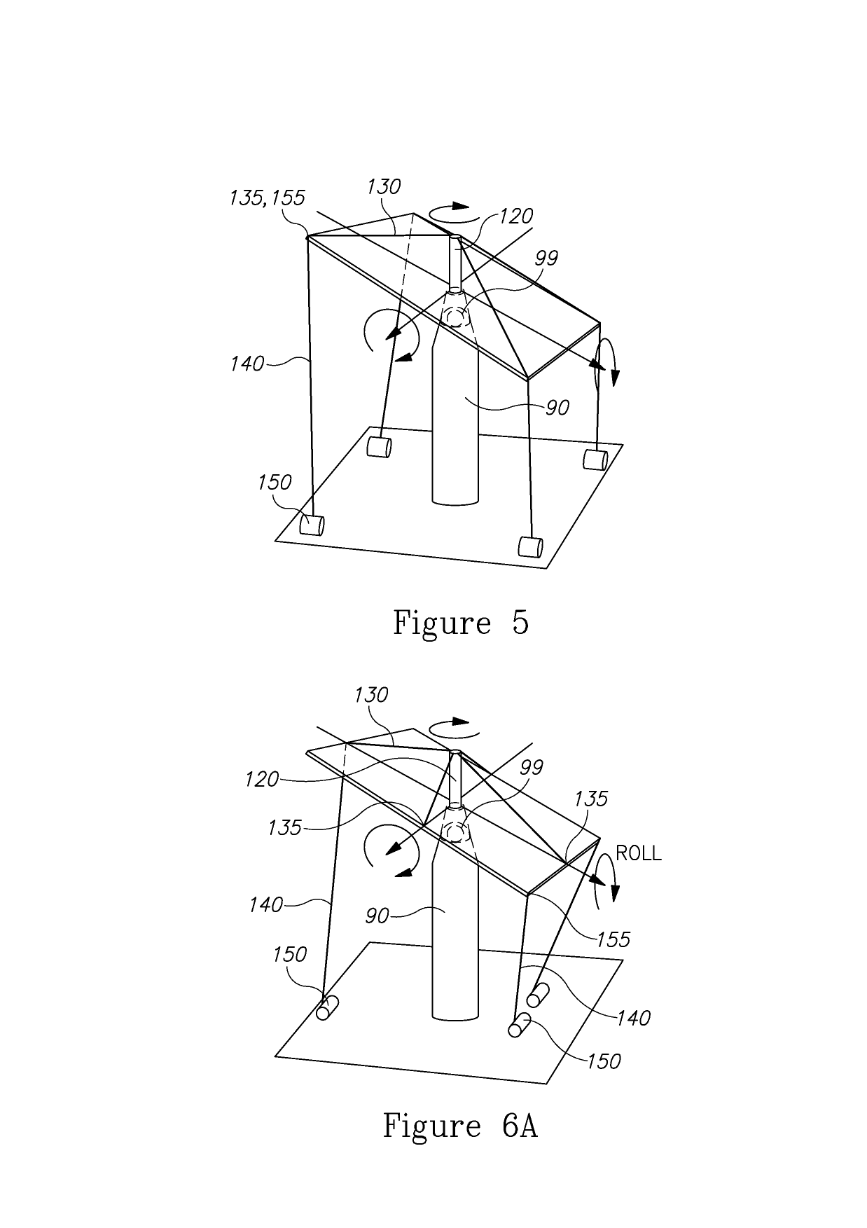

FIGS. 1-14 schematically illustrate positioning system 100 for solar modules 91 (see FIG. 12), according to some embodiments of the invention.

Positioning system 100 comprises a utility platform 110 arranged to hold solar modules 91, for example by means of racks 93 (FIGS. 12-14). Solar modules 91 may comprise solar panels, mirrors, or lenses of any design. Solar modules 91 may be flat or concave, intercepting, reflecting or concentrating solar radiation.

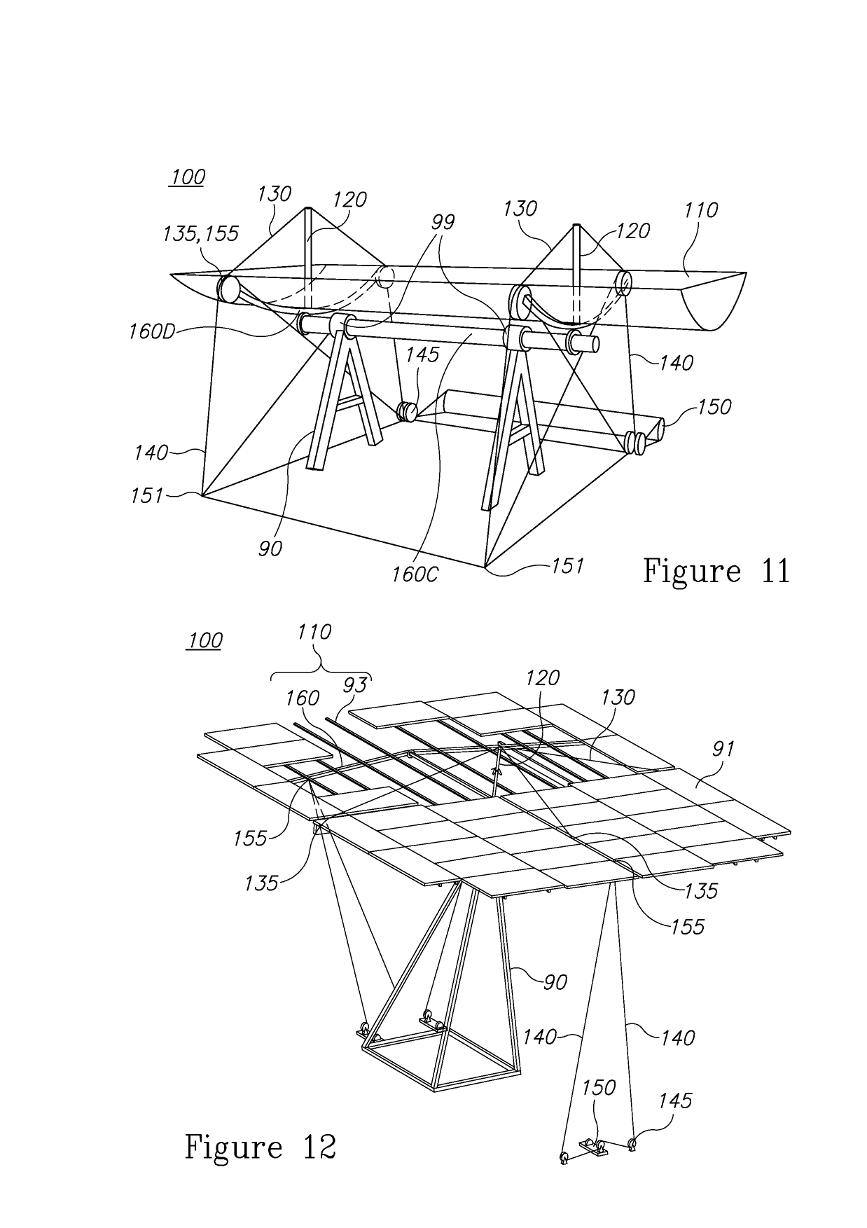

Utility platform 110 is connected to at least one ground support 90, at one or more supporting links 99. Ground support 90 may be a pole, a mast, a tower, pivoting pipe (FIG. 11) or any other supporting construction. Supporting links 99 may be a universal joint (such as a Cardan joint), a coupling, a bearing, a pivot etc. Supporting link 99 may be located centrally or near centrally on utility platform 110. Utility platform 110 may be arranged to be tiltable along up to three axes, designated by yaw, pitch and roll in FIG. 1.

Positioning system 100 may comprise multiple ground supports 90, or one ground support 90 with multiple supporting links 99. For example, as illustrated in FIG. 11, a horizontal pipe 160C may be connected to a trough shaped utility platform 110 (e.g. via brace 160D, both pipe 160C and brace 160D reinforcing utility platform 110) and several ground supports 90 may support utility platform 110 by pipe 160C at several supporting links 99. Ground supports 90 may be extendable, for example comprise pistons to allow further maneuvering of utility platform 110, beyond and in addition to the maneuverability provided by cords 140, ground elements 145 and at least one motor 150.

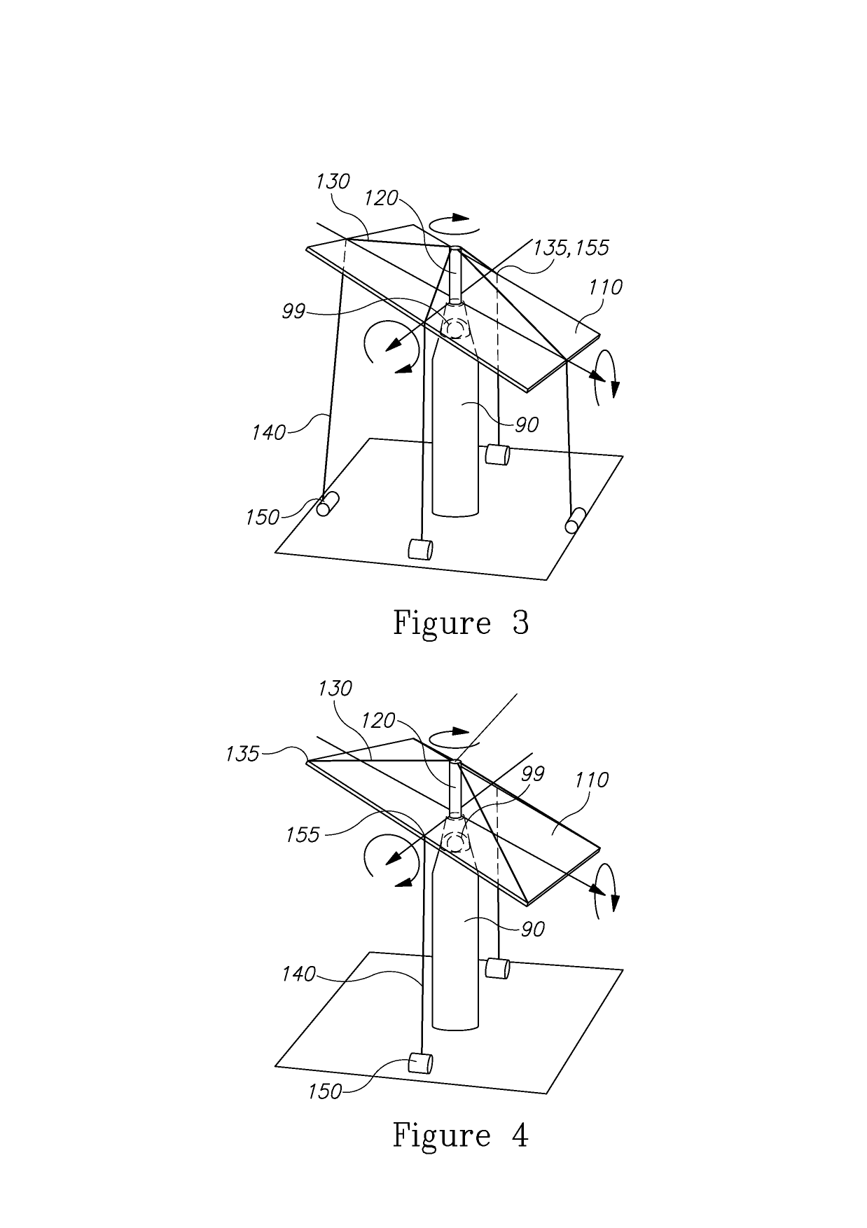

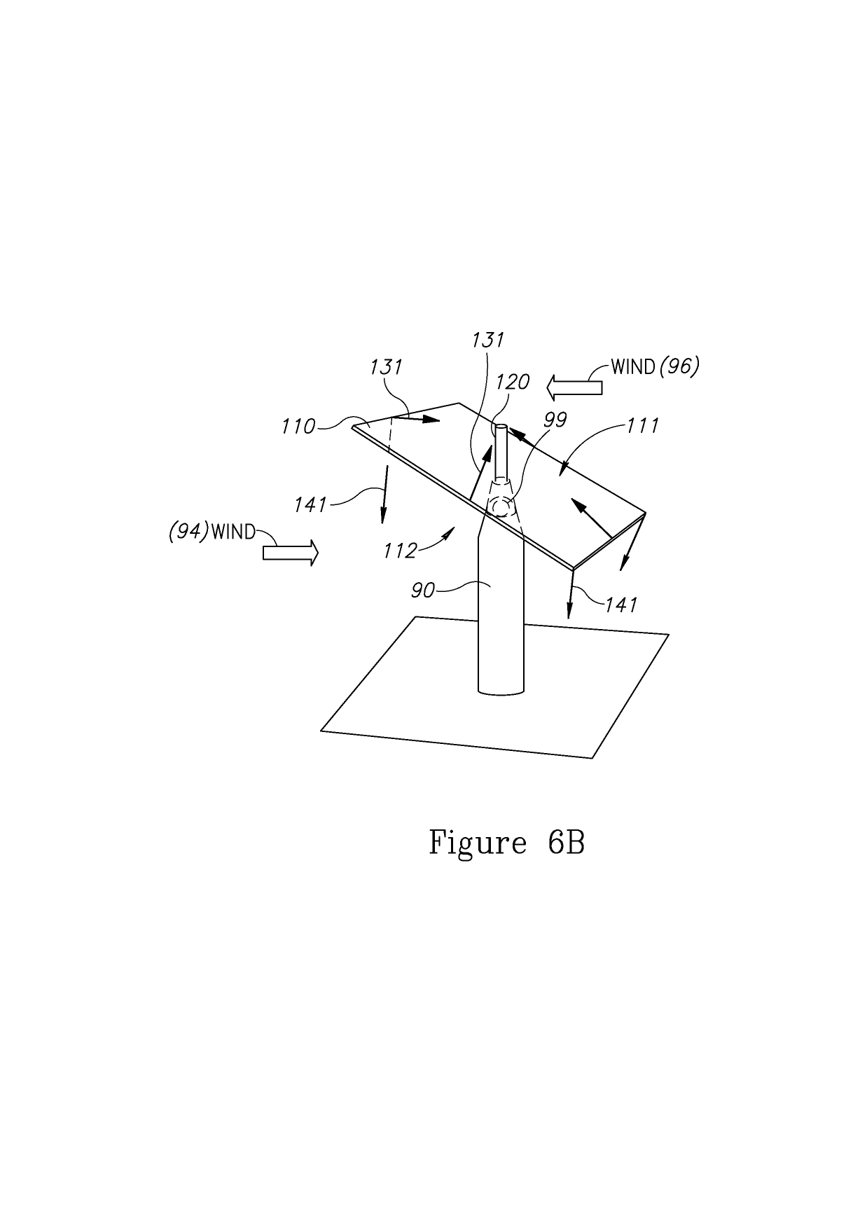

Positioning system 100 may be connected to ground supports 90 to allow turning movements of positioning system 100 in respect to one axis (e.g. FIGS. 1, 10, 11), two axes (e.g. FIG. 3) or three axes (e.g. FIG. 6A).

Utility platform 110 defines a plane having an upper side 111 and a lower side 112 (FIG. 6B). At least one extension 120 is connected to utility platform 110 and projects above upper side 111 of utility platform 110.

Utility platform 110 is supported by upper suspension elements 130 from extension(s) 120 at upper contact points 135 on utility platform 110.

Utility platform 110 is supported by taut cords 140 to at least one ground element 145, 150 (including at least one motor, e.g. motor 150 in FIG. 11) at lower contact points 155 on utility platform 110. Motor 150 is arranged (via elements 145) to change an orientation of utility platform 110 by controlling lengths and tensions of taut cords 140.

In embodiments, the design illustrated in FIG. 11 may be modified by using multiple motors 150, or using motors as ground elements 145. For example, each ground elements 145 may comprise two motors—one per each associated cord 140. Points 151 may be fixed or may include ground elements 145, such as pulleys or sheaves.

Positioning system 100 further comprises a controller (not shown) arranged to coordinate ground motor 150 to achieve a specified orientation of utility platform 110 under specified ranges of tensile forces 141 (FIG. 6B) in taut cords 140.

Upper suspension elements 130 are arranged to support a weight of utility platform 110 and together with taut cords 140 are arranged to maintain a form of utility platform 110 at a range of specified orientations and under a range of wind intensities (94, 96, FIG. 6B), by generating a resultant force that is opposite to a wind direction on an upwind side of utility platform 110. The upwind side may be either upper side 111 or lower side 112, according to the wind direction and the specified orientation.

FIGS. 1-5 and 6A illustrate different configurations of upper suspension elements 130 and taut cords 140. Taut cords 140 may be continuous to upper suspension elements 130 (FIGS. 1, 3, 5), separate from them (FIG. 4), wherein these two options may be mixed in system 100 (FIGS. 2, 6A). Upper contact points 135 and lower contact points 155 may be identical, close to each other or remote from each other. Some upper contact points 135 may be close to some lower contact points 155 and others may be remote. The numbers of upper contact points 135 and of lower contact points 155 may be equal or different. The locations of upper contact points 135 and of lower contact points 155 may be selected according to various considerations, including mechanical strength, maneuverability of utility platform 110 and shading on solar modules 91.

The combination of upper suspension elements 130 and taut cords 140 allows a significant reduction of the weight of utility platform 110 without compromising its strength and stability. Furthermore, the ability to withstand wind from both directions (upper side 111 and lower side 112) enables the operation of utility platform 110 in a wide range of tilting angles, thereby increasing the intercepted solar radiation. These two advantages enhance each other, as reducing the weight of utility platform 110 increases its maneuverability, and the effective countering of the wind allows additional weight reduction. The maneuverability is enhanced to the extent of enabling to reach steeper declinations of platform 110 in respect to using upper suspension elements 130 or taut cords 140 on themselves. The combination of upper suspension elements 130 and taut cords 140 also increases the robustness and rigidity of positioning system 100.

The relation between upper contact points 135 and lower contact points 155 may be adapted to installation circumstances. Upper contact points 135 and lower contact points 155 may be the same points (e.g. FIG. 1), such that each upper suspension element 130 is coupled with at least one taut cord 140.

A single taut cord may comprise both taut cord 140 and a corresponding upper suspension element 130, i.e. extension 120 may be connected over contact points 135, 155 to ground elements 145, 150.

Each taut cord 140 may be associated with ground motor 150, or several taut cords 140 may be associated, e.g. over pulleys or sheaves with one or more ground motors 150. Taut cord 140 may be coupled, such that lengthening one cord 140 is accompanied by shortening the coupled cord 140 (FIG. 12). The relative lengths of cords 140 attached to each ground element 145 define a declination of platform 110 in the respective axis. Ground element 145 may comprise mechanisms for compensating different cord lengths that are required to perform a specified declination, for example mechanisms for creating and releasing side loops of cords 140. Cords 140 attached to each ground element 145 may be continuous or may be discrete, and manipulated independently from each other.

Upper suspension elements 130 may be stiff rods, bars, profiles, hollow or solid pipes, or taut cords. Upper contact points 135 may be selected to minimize shading of upper suspension elements 130 on solar modules 91.

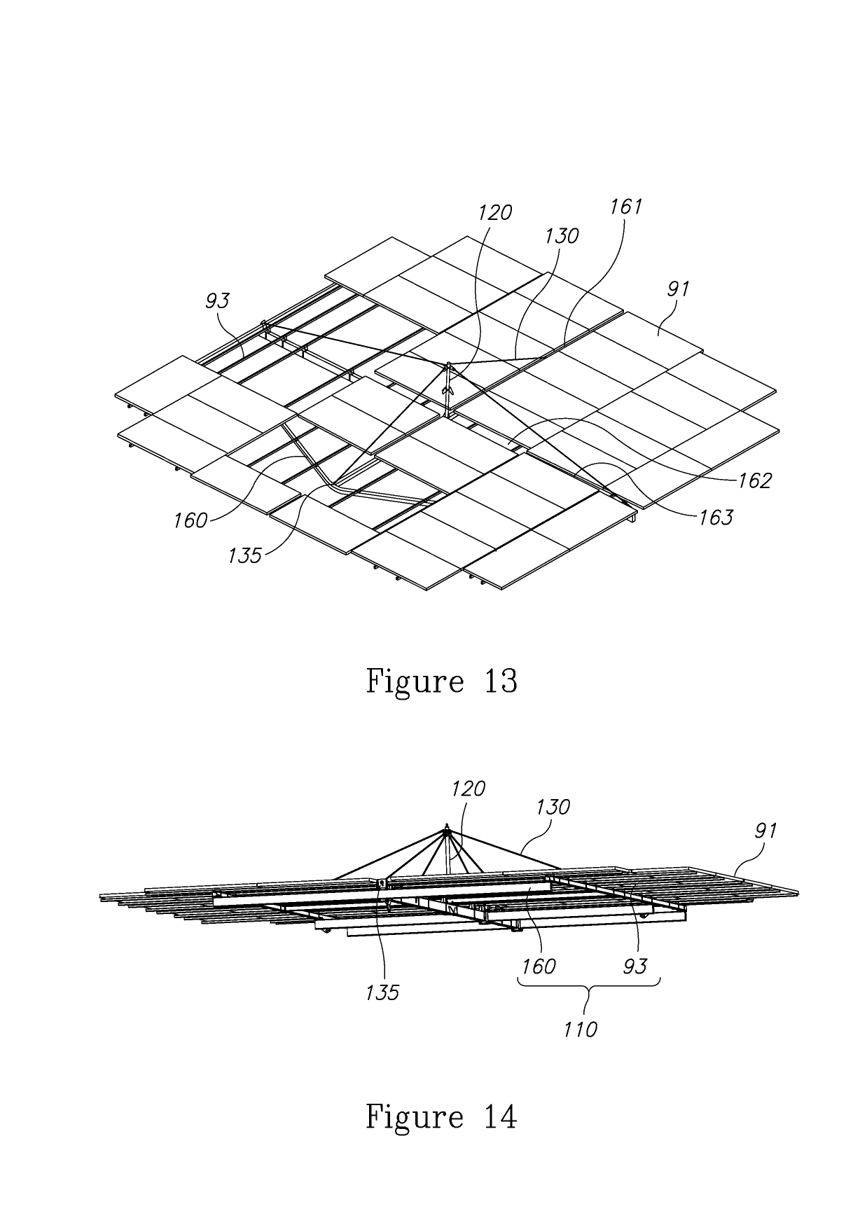

Solar modules 91 may be arranged to leave gaps (161, 162, 163 in FIG. 13) between adjacent solar modules 91 to accommodate the shades of upper suspension elements 130 during a daily motion of utility platform 110. The gaps may be selected to include all the shading of upper suspension elements 130 and extension 120, and thereby to minimize shading of solar modules 91.

Upper contact points 135 may be selected on two mutually perpendicular axes, and gaps 161, 162, 163 between solar modules 91 may be left along the two mutually perpendicular axes. A width of gaps 161, 162, 163 may be selected to receive shading from upper suspension elements 130 during the motion of utility platform 110, according to daily and seasonal sun position. Gap 162 may be wider than gaps 161, 163 to accommodate shading of extension 120 in cases that extension 120 is not directed to the sun. These situations may be anticipated at known positioning and operation patterns, and taken into consideration by spacing solar modules 91 in the corresponding directions.

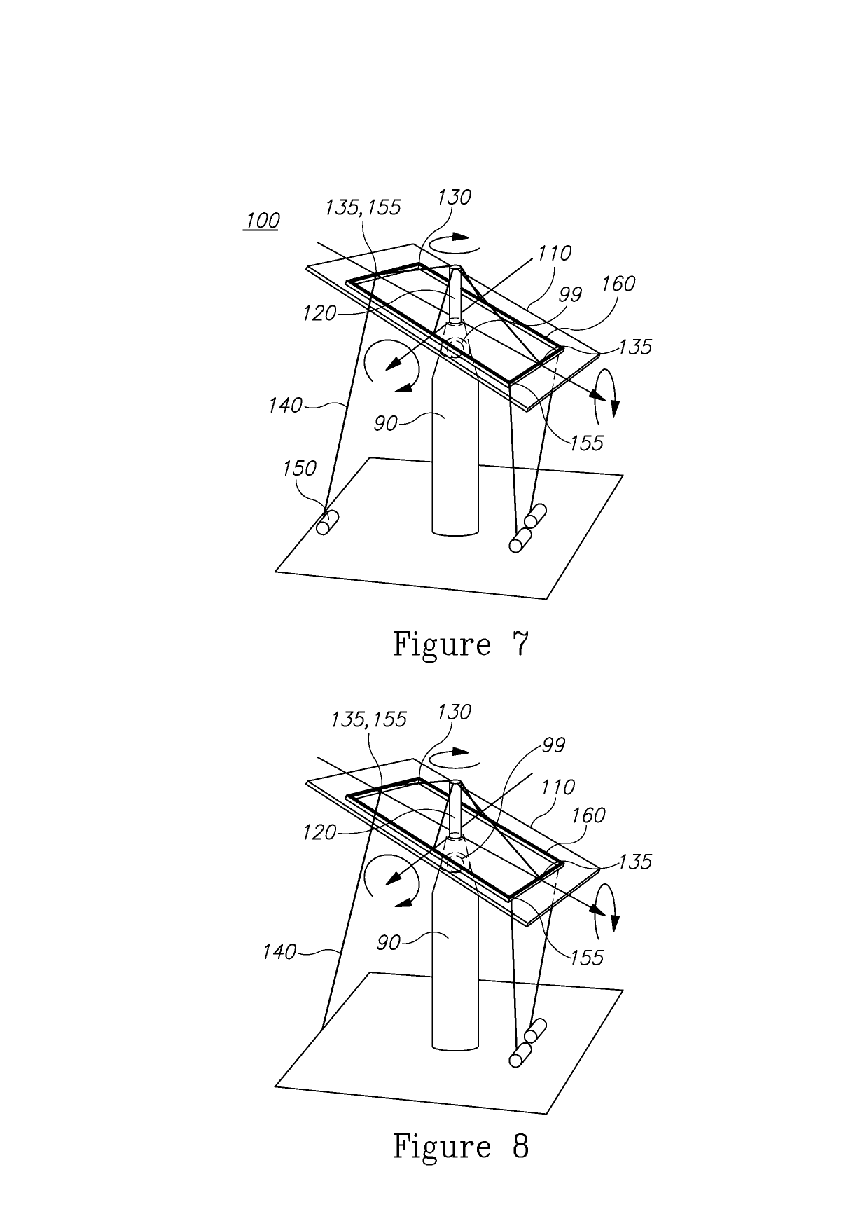

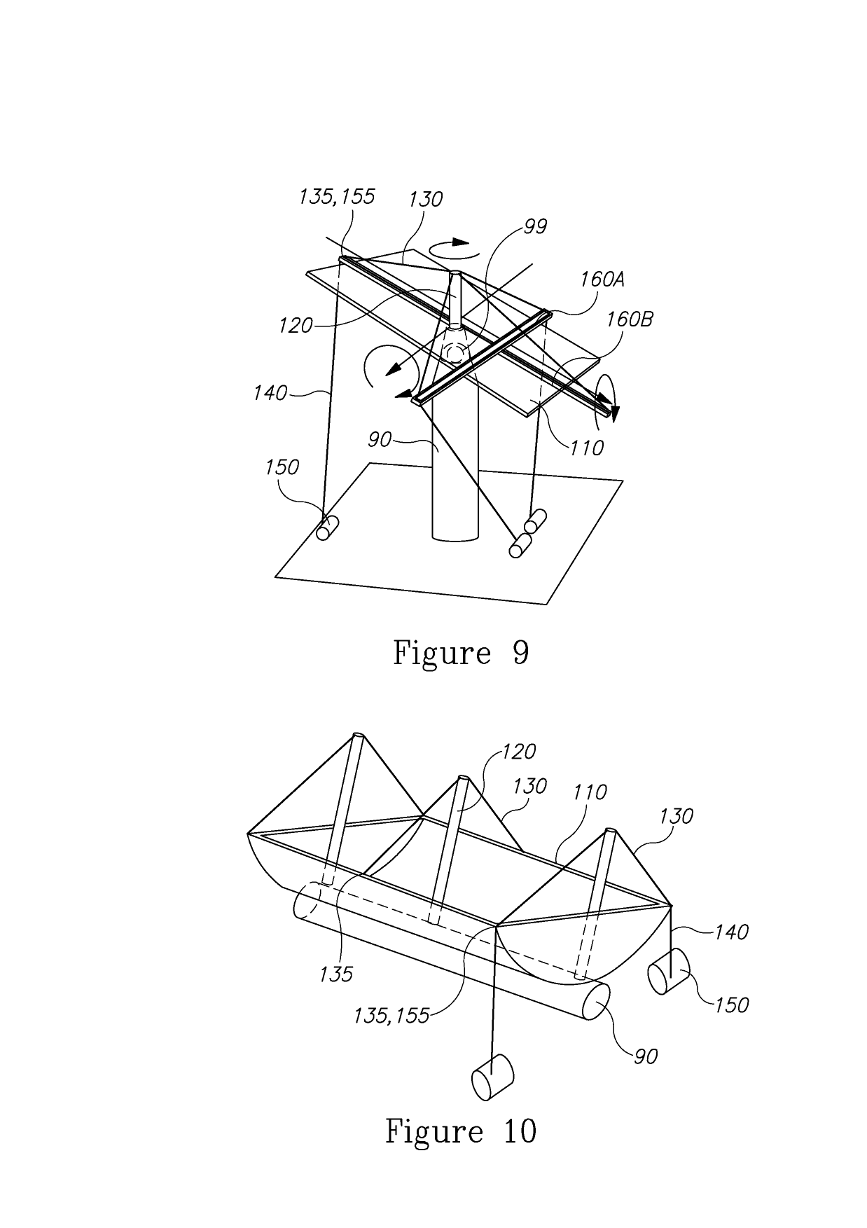

Utility platform 110 may comprise a reinforcement 160 to which upper suspension elements 130 and taut cords 140 are connected (e.g. FIGS. 8, 9, 12-14). Reinforcement 160 may be rectangular (FIGS. 7, 8), comprise two mutually perpendicular beams 160A, 160B (FIG. 9), or have a polygonal form with cross beams (FIGS. 12-14). Utility platform 110 may comprise trusses, or be fully truss-like.

Utility platform 110 may be concave, e.g. trough shaped (FIG. 11) and supported by ground support 90 at an axis (such as pipe 160C), in respect to which, utility platform 110 may be tilted. For example, utility platform 110 may support concentrating mirrors of a solar thermal facility. Extension 120 may comprise a plurality of parallel extensions 120 connected by to the axis by upper suspension elements 130. Taut cords 140 may be connected to utility platform 110 at two or more lower contact points 155.

Advantageously, system 100 improves the maneuverability and the rigidity of utility platform 110 and achieves the following advantages, all of them promote significantly the ability to utilize solar irradiance as an energy source: (i) Affordability. A central bottleneck in using solar energy is the cost of the supporting platform. The invention allows a significant reduction in platform weight and thus in platform cost. (ii) Safety. The system resists much higher wind speeds, which are a great problem, especially for facilities with large platforms. (iii) Efficiency. The system configuration allows reaching much steeper angles of platform 110, which increases significantly the exploitation of solar irradiance, especially in high latitudes.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A positioning system for holding solar modules, comprising:
a utility platform arranged to hold the solar modules, the utility platform connected to at least one ground support at at least one supporting link, and defines a plane having an upper side and a lower side,
at least one extension connected to the utility platform and projecting above the upper side of the utility platform,
a plurality of upper suspension elements connecting the at least one extension to a plurality of upper contact points on the utility platform,
a plurality of taut cords connecting a plurality of lower contact points on the utility platform to at least one ground motor that is arranged to change an orientation of the utility platform by controlling lengths and tensions of the taut cords, and
a controller arranged to coordinate the at least one ground motor to achieve a specified orientation of the utility platform under specified ranges of tensile forces in the taut cords;
wherein the upper suspension elements are arranged to support a weight of the utility platform, and further arranged, together with the taut cords, to maintain a form of the utility platform at a range of specified orientations and under a range of wind intensities, by generating a resultant force that is opposite to a wind direction on an upwind side of the utility platform, the upwind side being either the upper side or the lower side, according to the wind direction and the specified orientation.

2. The positioning system of claim 1, wherein the upper suspension elements are rods and the upper contact points are selected to minimize shading of the rods on the solar modules.

3. The positioning system of claim 1, wherein at least one of the upper contact points and at least one of the lower contact points are identical, such that each upper suspension element is coupled with at least one taut cord.

4. The positioning system of claim 1, wherein each taut cord is associated with a ground motor.

5. The positioning system of claim 1, wherein the upper contact points are selected on two mutually perpendicular axes.

6. The positioning system of claim 5, wherein the solar modules are arranged to leave a gap between adjacent solar modules along the two mutually perpendicular axes.

7. The positioning system of claim 6, wherein a width of the gap is selected to receive shading from the upper suspension elements and the at least one extension during a motion of the utility platform.

8. The positioning system of claim 1, wherein the utility platform comprises a reinforcement to which the upper suspension elements and the taut cords are connected.

9. The positioning system of claim 8, wherein the reinforcement comprises at least one of: a rectangle, two mutually perpendicular beams, a truss, and a polygonal form with cross beams.

10. The positioning system of claim 1, wherein the utility platform is concave and supported by the at least one ground support at an axis, and wherein the at least one extension comprises a plurality of parallel extensions connected to the axis.
